(19) United States
(12) Patent Application Publication
(10) Pub. No.: US 2019/0359775 A1
(43) Pub. Date: Nov. 28, 2019

(54) COATING LIQUID AND ITS USE ARTICLE

(71) Applicant: JNC CORPORATION, Tokyo (JP)

(72) Inventors: Akihiro EZOE, Chiba (JP); Kyoko KONDO, Chiba (JP)

(73) Assignee: JNC CORPORATION, Tokyo (JP)

(21) Appl. No.: 16/417,663

(22) Filed: May 21, 2019

(30) Foreign Application Priority Data
May 23, 2018 (JP) 2018-099076

(51) Int. Cl. C08G 77/442; C09D 183/10; C09J 7/38; C09J 7/29

(52) U.S. Cl. CPC C08G 77/442; C09D 183/10; C09J 7/38; C09J 2205/114; C09J 2475/006; C09J 2453/006; C09J 7/29

(57) ABSTRACT

A coating that maintains favorable water-repelling and stain-proofing properties is provided. A photopolymerizable coating composition includes a component (a): a urethane (meth)acrylate and a component (b): photopolymerizable (meth)acrylic compounds, as photopolymerizable components, wherein the component (b) includes a component (b1): a photopolymerizable acrylic compound having a structural unit derived from a fluorosilsesquioxane derivative represented by the following Formula (1); a component (b2): a fluorine surfactant, and a component (b3): a photopolymerizable acrylic compound having no urethane units and having no fluorine atoms.

### CROSS-REFERENCE TO RELATED APPLICATION

This application claims the priority of Japan patent application serial no. 2018-099076, filed on May 23, 2018. The entirety of the above-mentioned patent application is hereby incorporated by reference herein and made a part of this specification.

### BACKGROUND

### Technical Field

The present disclosure relates to a coating liquid that can be used as a material of a top coating layer of various articles and particularly a laminated film such as a paint protection film.

### Description of Related Art

A paint protection film (PPF) is a film-like product that is used for surface protection of an industrial product used outdoors. A basic structure of the PPF is a laminate that includes at least two layers including a substrate made of a flexible and transparent resin film and an adhesive layer. Thus, a PPF in the form of a laminated film that includes a coating layer for enhancing a stain-proofing function and scratch resistance of a substrate on a surface opposite to the adhesive layer of the substrate and further includes a release layer on a surface opposite to the substrate of the adhesive layer has been supplied on the market. When the PPF is used, first, the PPF is cut according to a surface part of an industrial product to be protected, and an adhesive layer of the cut PPF is brought into close contact with a protection target surface. A product whose surface is covered with a PPF is protected from various stimuli from the outside such as dirt and scratches due to wind and rain, dust, sand, river water, microorganisms and contact with or excretions of animals and plants and insects while a coating, shape, and appearance of the product are not impaired. Specifically, the PPF serves as a so-called cushion and buffers a pressure or strike from the outside, and the PPF repels rainwater and dirt. Therefore, effects of external stimulation on the product itself are minimized.

Initially, such a PPF was developed for industrial products used in a harsh environment such as an airplane, but it is becoming popular as a protection member of a surface of a body such as an automobile and a motorbike nowadays. For example, when a roof, hood, front, doors, and trunk door of an automobile are covered with a PPF, the body can be protected from bird feces, insect carcasses, cat footprints, malicious actions, scratches during transport, or scratches due to scattered stones which bother a driver. In general, when a surface covered with a PPF is washed with water, since it is possible to simply remove dirt on the surface of the PPF, the PPF can be used for a relatively long period. A PPF which has used for a certain period can be separated from the body and simply replaced with a new PPF.

Due to the recent spread of vehicles such as automobiles and motorbikes worldwide, there is a demand for PPFs that can be used in wider environments, for example, in more severe climates such as cold areas, tropical areas, and arid areas. Moreover, with the expansion of the PPF market, PPFs that can be appropriately applied by a worker without special skills more simply are desirable. Therefore, in recent PPFs, various aspects of performance such as flexibility for adaption to variable surface shapes of automobiles or motorbikes, durability to withstand stimulation from the outside for a long period, transparency and smoothness for preventing an appearance of the product itself from being impaired, and favorable detachability during replacement have been required.

As such a PPF, for example, in Patent Document 1, there is provided a PPF which has excellent sticking characteristics and in which there is less adhesive residue due to laminating a substrate film and an adhesive layer whose surface roughness is controlled. However, in this PPF, a detailed examination of a stain-proofing layer added to a surface of the substrate film was not performed, and there was a problem in practicality for automobiles and motorbikes whose appearances are considered to be important.

In addition, for example, in Patent Document 2, a PPF in which a first layer containing polyurethane, a second layer containing a thermoplastic polyurethane, and a third layer containing a pressure sensitive adhesive are laminated in that order is described. However, further improvement in various aspects of performance is required for this PPF.

There is room for improvement in such prior PPF technology. In improving performance, the inventors have focused particularly on weathering resistant stability that has not been studied in the above prior technology, that is, maintaining initial stain-proofing and water-repelling properties even after use in a harsh outdoor environment for a long period. The inventors aimed at improvement of the weathering resistant stability by modifying a coating material constituting the outermost surface of a PPF.

As a result, the inventors found that an acrylic photopolymerizable coating composition containing two specific types of fluorine-containing photopolymerizable component provides a coating (coating layer) that exhibits long lasting stain-proofing and water-repelling properties. In addition, the inventors found that a coating layer formed of a cured product of the photopolymerizable coating composition can be used as a laminated film such as a PPF. Specifically, the present disclosure is as follows.

### PATENT DOCUMENTS

[Patent Document 1] Japanese Patent Laid-Open No. 2016-020079
[Patent Document 2] Published Japanese Translation No. 2008-539107 of the PCT International Publication

### SUMMARY

(Disclosure 1) A photopolymerizable coating composition, including: a component (a): a urethane (meth)acrylate and a component (b): photopolymerizable (meth)acrylic compounds, as photopolymerizable components, wherein the component (a) and the component (b) are mixed so that a proportion of the component (a) is 1 weight % or more and 50 weight % or less, and a proportion of the component (b) is 50 weight % or more and 99 weight % or less with respect to a total amount of the photopolymerizable components, and wherein the component (b) includes a component (b1): a photopolymerizable acrylic compound having a structural unit derived from a fluorosilsesquioxane derivative represented by the following Formula (1); a component (b2): a fluorine surfactant, and a component (b3): a photopolymerizable acrylic compound having no urethane units and having no fluorine atoms:

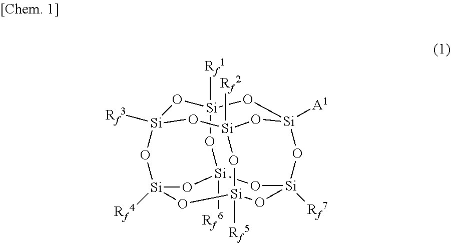

In Formula (1), R_{f}¹ to R_{f}⁷ each independently represent a linear or branched fluoroalkyl group having 1 to 20 carbon atoms in which any methylene is optionally substituted with an oxygen atom; a fluoroaryl group having 6 to 20 carbon atoms in which at least one hydrogen atom is substituted with a fluorine atom or a trifluoromethyl group; or a fluoroarylalkyl group having 7 to 20 carbon atoms in which at least one hydrogen atom in an aryl group is substituted with a fluorine atom or a trifluoromethyl group, and A¹ is a group represented by the following Formula (1-1) or Formula (1-2).

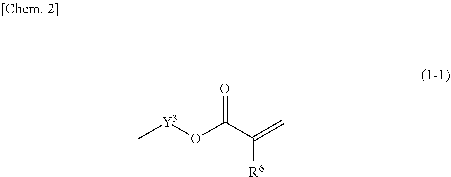

In Formula (1-1), Y³ represents an alkylene group having 2 to 10 carbon atoms, and R⁶ represents a hydrogen atom, a linear alkyl group having 1 to 5 carbon atoms, a branched alkyl group having 3 to 5 carbon atoms, or an aryl group having 6 to 10 carbon atoms.

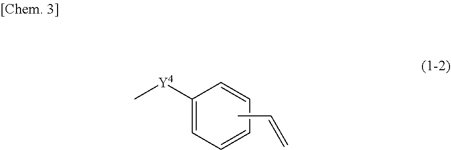

In Formula (1-2), Y⁴ represents a single bond or an alkylene group having 1 to 10 carbon atoms.

(Disclosure 2) The photopolymerizable coating composition according to disclosure 1, wherein the component (b1) has a structural unit derived from γ-methacryloxypropyl hepta(trifluoropropyl)-T8-silsesquioxane represented by the following Formula (1-3), and wherein the component (b2) is a perfluoropolyether compound which has a perfluoropolyether framework and has a (meth)acryloyl group as a photopolymerizable unsaturated group at one end or both ends.

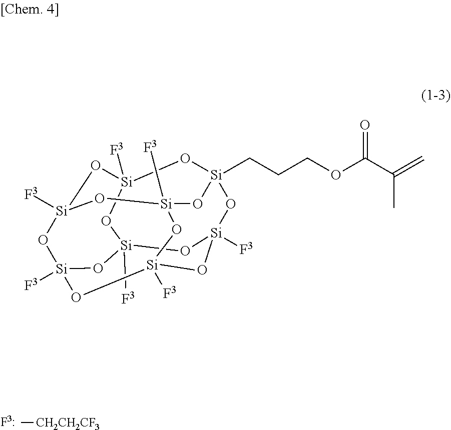

(Disclosure 3) An article having a coating layer formed of a cured product of the photopolymerizable coating composition according to disclosure 1 or disclosure 2.

(Disclosure 4) A laminated film in which a coating layer formed of a cured product of the photopolymerizable coating composition according to disclosure 1 or 2, a substrate layer formed of a thermoplastic polyurethane, an adhesive layer formed of a pressure sensitive adhesive, and a release layer whose surface is covered with a fluorine or silicone release agent are in contact in this order.

(Disclosure 5) A paint protection film using the laminated film according to disclosure 4.

### BRIEF DESCRIPTION OF THE DRAWINGS

FIG. 1 is a diagram schematically showing one example of a laminated film of the present disclosure.

FIG. 2 is a diagram schematically showing a state in which the laminated film of the present disclosure is used as a PPF.

### DESCRIPTION OF THE EMBODIMENTS

Favorable stain-proofing and water-repelling properties of the coating (coating layer) obtained using the photopolymerizable coating composition of the present disclosure are maintained even after use outdoors for a long period.

[1. Photopolymerizable Coating Composition]

A photopolymerizable coating composition of the present disclosure contains, as photopolymerizable components serving as essential components, a component (a) to be described below: a urethane (meth)acrylate and a component (b) to be described below: photopolymerizable (meth)acrylic compounds. In the photopolymerizable coating composition of the present disclosure, the component (a) and the component (b) may be in a diluted state or in an undiluted polymer state.

In the present disclosure, the component (a) and the component (b) are mixed such that a proportion of the component (a) is 1 weight % or more and 50 weight % or less and a proportion of the component (b) is 50 weight % or more and 99 weight % or less, and preferably a proportion of the component (a) is 1 weight % or more and 30 weight % or less, and a proportion of the component (b) is 70 weight % or more and 99 weight % or less with respect to a total amount of the photopolymerizable components.

[Component (a): Urethane (Meth)Acrylate]

The urethane (meth)acrylate used as the component (a) is a general term for an oligomeric compound which is obtained by a reaction of an isocyanate compound, a polyol, a hydroxyl group-containing (meth)acrylic monomer, and an isocyanate group-containing (meth)acrylic monomer, and which includes a reactive (meth)acryloyl group at its terminal.

The urethane (meth)acrylate used in the present disclosure is typically a UV curable urethane (meth)acrylate, and preferably, a urethane (meth)acrylate obtained by reacting (I) an isocyanate compound including an aliphatic isocyanate compound and/or an alicyclic isocyanate compound, (II) an ester polyol, (III) an ether polyol, (IV) at least one polyol compound selected from among polycarbonate polyols, and (V) a hydroxyl group-containing (meth)acrylate compound.

(I) Regarding the aliphatic isocyanate compound, for example, hexamethylene diisocyanate, an isocyanurate modified product of hexamethylene diisocyanate, and trimethylhexamethylene diisocyanate may be exemplified. Regarding the alicyclic isocyanate compound, for example, isophorone diisocyanate, 4,4′-dicyclohexylmethane isocyanate, and hydrogenated xylene diisocyanates may be exemplified.

(II) Regarding the ester polyol, for example, an ester compound obtained by reacting diols with a dicarbonic acid may be exemplified. Regarding the diols, for example, 3-methyl-1,5-pentanediol, neopentyl glycol, ethylene glycol, diethylene glycol, propylene glycol, dipropylene glycol, 1,3-butanediol, 1,4-butanediol, 1,6-hexanediol, 2-methyl-1,8-octanediol, and 1,9-nonanediol may be exemplified. Regarding the dicarboxylic acid, sebacic acid, adipic acid, dimer acids, succinic acid, azelaic acid, maleic acid, terephthalic acid, isophthalic acid, and citraconic acid may be exemplified, and an anhydride thereof may be used.

(III) Regarding the ether polyol, for example, polyether diol, poly(oxytetramethylene)glycol, and poly(oxybutylene)glycol may be exemplified. Regarding a specific example of the polyether diol, polypropylene glycol, polyethylene glycol, polytetramethylene glycol, and propylene-modified polytetramethylene glycol may be exemplified.

(IV) Regarding the polycarbonate polyol, for example, a reaction product of a carbonate derivative and diols may be exemplified. Regarding examples of the carbonate derivative, a diallyl carbonate such as diphenyl carbonate, dimethyl carbonate, and diethyl carbonate may be exemplified. In addition, regarding the diols, the above compounds may be exemplified.

(V) Regarding the acrylate compound having a hydroxyl group, 2-hydroxyethyl (meth)acrylate, 2-hydroxypropyl (meth)acrylate, 2-hydroxybutyl (meth)acrylate, 4-hydroxybutyl (meth)acrylate, polyethylene glycol mono(meth)acrylate, polypropylene glycol mono(meth)acrylate and the like may be exemplified.

In production of such a urethane acrylate, an isocyanate compound, a polyol compound, and an acrylate compound having a hydroxyl group which are essential components can be reacted in a collective manner. Alternatively, a (meth)acrylate compound having a hydroxyl group and such an isocyanate compound may be first reacted to prepare a prepolymer having excess isocyanate groups, and then residual isocyanate groups can be reacted with a polyol compound.

Alternatively, an isocyanate compound and a polyol compound may be first reacted to prepare a prepolymer having excess isocyanate groups, and then residual isocyanate groups can be reacted with a (meth)acrylate compound having a hydroxyl group. A urethane (meth)acrylate produced by such a method preferably has a polyurethane chain.

In the present disclosure, commercial products P7-532 (commercially available from Kyoeisha Chemical Co., Ltd.), Purple Light UT-5569 (Nippon Synthetic Chemical Industry Co., Ltd.), AUP-838 (commercially available from Tokushiki Co., Ltd.), and RUA-012, RUA048, RUA-062S, RUA-075, RUA-058SY2 (commercially available from Asia Industry Co., Ltd.) can be used.

[Component (b): Photopolymerizable (Meth)Acrylic Compounds]

The component (b) is photopolymerizable (meth)acrylic compounds and contains a component (b1): a photopolymerizable acrylic compound having a structural unit derived from a fluorosilsesquioxane derivative represented by the following Formula (1), a component (b2): a fluorine surfactant, and a component (b3): a photopolymerizable acrylic compound having no urethane units and having no fluorine atoms. The component (b1), the component (b2), and the component (b3) are mixed in a diluted state or in an undiluted polymer state.

The proportion of each of the component (b1), the component (b2), and the component (b3) in the component (b) is not particularly limited. Generally, respective components are blended in so that a total amount of the component (b1) and the component (b2) is 0.1 weight % or more and 10 weight % or less, and preferably 0.5 weight % or more and 5 weight % or less with respect to a total amount of the component (b). In addition, generally, based on the mass, the component (b2) is combined with 0.1 times or more and 10 times or less, and preferably 0.2 times or more and 5 times or less the amount of the component (b1). In the present disclosure, when the component (b2) is combined with the component (b1), a synergistic effect is obtained.

[Component (b1): photopolymerizable acrylic compound having a structural unit derived from a fluorosilsesquioxane derivative]

The component (b1) contained in the component (b) of the present disclosure has a fluorosilsesquioxane structure and is generally classified into a random type structure, a ladder type, and a cage type structure according to an Si—O—Si framework thereof. Among these, a photopolymerizable (meth)acrylic compound having a structural unit derived from a fluorosilsesquioxane derivative represented by the following Formula (1) is particularly preferable.

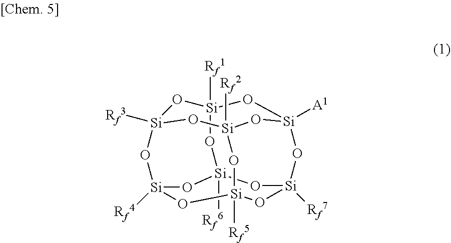

In Formula (1), R_{f}¹ to R_{f}⁷ each independently represent a linear or branched fluoroalkyl group having 1 to 20 carbon atoms in which any methylene is optionally substituted with an oxygen atom; a fluoroaryl group having 6 to 20 carbon atoms in which at least one hydrogen atom is substituted with a fluorine atom or a trifluoromethyl group; or a fluoroarylalkyl group having 7 to 20 carbon atoms in which at least one hydrogen atom in an aryl group is substituted with a fluorine atom or a trifluoromethyl group, and A¹ is a group represented by the following Formula (1-1) or Formula (1-2).

Preferably, in Formula (1), R_{f}¹ to R_{f}⁷ each independently represent 3,3,3-trifluoropropyl, 3,3,4,4,4-pentafluorobutyl, 3,3,4,4,5,5,6,6,6-nonafluorohexyl, tridecafluoro-1,1,2,2-tetrahydrooctyl, heptadecafluoro-1,1,2,2-tetrahydrodecyl, henicosafluoro-1,1,2,2-tetrahydrododecyl, pentacosafluoro-1,1,2,2-tetrahydrotetradecyl, (3-heptafluoroisopropoxy)propyl, pentafluorophenylpropyl, pentafluorophenyl, or A,A,A-trifluoromethylphenyl.

More preferably, in Formula (1), R_{f}¹ to R_{f}⁷ each independently represent 3,3,3-trifluoropropyl or 3,3,4,4,5,5,6,6,6-nonafluorohexyl.

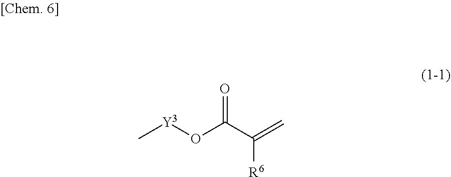

In Formula (1-1), Y³ represents an alkylene group having 2 to 10 carbon atoms, and preferably an alkylene group having 2 to 6 carbon atoms, R⁶ represents a hydrogen atom, a linear or branched alkyl group having 1 to 5 carbon atoms or an aryl group having 6 to 10 carbon atoms, and preferably a hydrogen atom or an alkyl group having 1 to 3 carbon atoms.

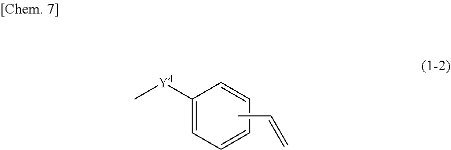

In Formula (1-2), Y⁴ represents a single bond or an alkylene group having 1 to 10 carbon atoms.

The fluorosilsesquioxane derivative (1) is produced by the following method. First, when a silicon compound (2) having a trifunctional hydrolyzable group represented by the following Formula (2) is hydrolyzed and polycondensed in an oxygen-containing organic solvent in the presence of an alkali metal hydroxide, a compound (3) represented by the following Formula (3) is produced.

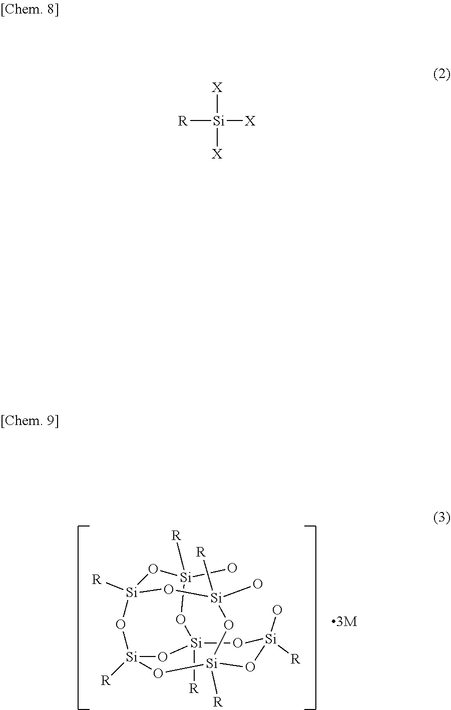

In Formula (3), M is not particularly limited as long as it is an alkali metal. As such an alkali metal, for example, lithium, sodium, potassium, and cesium, may be exemplified.

In Formulas (2) and (3), R each independently correspond to one group selected from among R_{f}¹ to R_{f}⁷ in Formula (1), and represent a linear or branched fluoroalkyl group having 1 to 20 carbon atoms in which any methylene is optionally substituted with an oxygen atom; a fluoroaryl group having 6 to 20 carbon atoms in which at least one hydrogen atom is substituted with a fluorine atom or a trifluoromethyl group; or a fluoroarylalkyl group having 7 to 20 carbon atoms in which at least one hydrogen atom in an aryl group is substituted with a fluorine atom or a trifluoromethyl group, and X represents a hydrolyzable group.

Preferably, in Formulas (2) and (3), R each independently represent 3,3,3-trifluoropropyl, 3,3,4,4,4-pentafluorobutyl, 3,3,4,4,5,5,6,6,6-nonafluorohexyl, tridecafluoro-1,1,2,2-tetrahydrooctyl, heptadecafluoro-1,1,2,2-tetrahydrodecyl, henicosafluoro-1,1,2,2-tetrahydrododecyl, pentacosafluoro-1,1,2,2-tetrahydrotetradecyl, (3-heptafluoroisopropoxy)propyl, pentafluorophenylpropyl, pentafluorophenyl, or A,A,A-trifluoromethylphenyl.

More preferably, in Formula (2), R each independently represent 3,3,3-trifluoropropyl or 3,3,4,4,5,5,6,6,6-nonafluorohexyl.

Next, the compound (3) is reacted with a compound (4) represented by the following Formula (4) to obtain the fluorosilsesquioxane derivative (1).

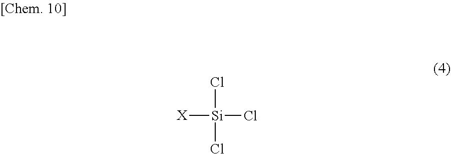

In Formula (4), the group X is a group represented by Formula (1-1) or Formula (1-2).

Among such fluorosilsesquioxane derivatives (1), γ-methacryloxypropyl hepta(trifluoropropyl)-T8-silsesquioxane represented by the following Formula (5) is preferable.

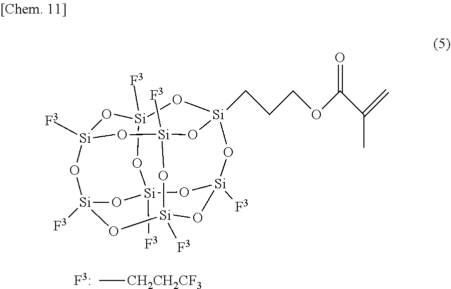

When the fluorosilsesquioxane derivative (1) such as γ-methacryloxypropyl hepta(trifluoropropyl)-T8-silsesquioxane is introduced into the coating layer, it is possible to further improve a stain-proofing function of the coating layer. When the fluorosilsesquioxane derivative (1) is contained in photopolymerizable acrylic compounds, it may be directly mixed with photopolymerizable acrylic compounds, or an oligomer prepared by crosslinking and/or polymerizing this and photopolymerizable acrylic compounds having no urethane units in advance may be mixed with photopolymerizable acrylic compounds.

Generally, the fluorosilsesquioxane derivative (1) is copolymerized with at least one (meth)acrylate copolymer component selected from among a monofunctional acrylate, a bifunctional acrylate, and a multifunctional acrylate to prepare a polymer having the fluorosilsesquioxane derivative (1) unit in advance, and this polymer is used as a part of photopolymerizable (meth)acrylic compounds containing a fluorine atom. In this case, the polymer having the fluorosilsesquioxane derivative (1) unit is blended in in a proportion of 0.01 to 10 weight %, and preferably 0.05 to 5 weight % with respect to a total amount of the photopolymerizable coating composition.

As the at least one (meth)acrylate copolymer component, a compound that is generally referred to as a photocurable acrylic monomer, for example, a monofunctional acrylate such as (meth)acrylic acid, (meth)acrylic ester and a hydroxy group-containing (meth)acrylic ester, a bifunctional acrylate such as (poly)alkylene glycol di(meth)acrylate, and a trifunctional or higher functional acrylate such as pentaerythritol triacrylate, and additionally an oligomer obtained by polymerizing these can be used.

[Component (b2): Fluorine Surfactant]

The component (b2) used in the present disclosure is a monomer or oligomer having a fluorine atom and a photopolymerizable unsaturated group in its chemical structure, and refers to a material group called a fluorine additive, a fluorine surfactant, or a fluorine surface modifier in the field of paints. In this specification, for convenience, the component (b2) is referred to as a “fluorine surfactant” which is a general term.

Regarding the component (b2), a nonionic component in which component separation does not occur in the photopolymerizable coating composition of the present disclosure and which is highly soluble in various organic solvents (for example, an ether solvent, an ester solvent, a ketone solvent, and an alcohol solvent) is preferable. In addition, a component (b2) containing 0.01 to 80 weight % of fluorine is preferable.

Regarding a preferable component (b2), a perfluoropolyether compound having a perfluoropolyether framework and having a photopolymerizable unsaturated group at one end or both ends can be used. The perfluoropolyether framework has a repeating structure of, for example, —(O—CF₂CF₂)—, —(OCF₂CF₂CF₂)—, or —(O—CF₂C(CF₃)F)—. The photopolymerizable unsaturated group is not particularly limited, and (meth)acryloyl, (meth)acryloyl oxy, vinyl, and allyl groups may be exemplified, and a (meth)acryloyl group is preferable in consideration of the reactivity with the component (a) and the component (b).

Regarding such a component (b2), for example, “MEGAFACE (registered trademark) RS-75” (commercially available from DIC), “KY-1203” (commercially available from Shin-Etsu Chemical Co., Ltd.), “FLUOROLINK AD1700” “FLUOROLINK MD700” (commercially available from Solvay Specialty Polymers Japan K.K.), “Optool DAC-HP” (commercially available from Daikin Industries, Ltd.), and “CN4000” (commercially available from Sartomer) can be used.

[Component (b3): Photopolymerizable Acrylic Compound Having No Urethane Units and Having No Fluorine Atoms]

In the photopolymerizable coating composition of the present disclosure, as a crosslinking agent or copolymerizable monomer that is photopolymerized with at least one component of the above component (a), component (b1), and component (b2), a component (b3): a photopolymerizable acrylic compound having no urethane units and having no fluorine atoms is contained. The component (b3) contributes to extension of polymer chains in the curing of the photopolymerizable coating composition of the present disclosure. A resin component mainly containing the component (b3) contained in the curing contributes to the strength of the coating (coating layer) generated in the curing. The component (b3) is selected from among various compounds and products available as a photopolymerizable acrylic compound or a solution containing the same, and the types thereof are not limited.

A form of the component (b3) that is mixed with at least one selected from among the above component (a), component (b1), and component (b2) in advance can be supplied to the photopolymerizable coating composition of the present disclosure. A copolymer obtained by reacting at least a part of the component (b3) with at least one selected from among the above component (a), component (b1), and component (b2) can be supplied to the photopolymerizable coating composition of the present disclosure.

[2. Polymerization Initiator]

Regarding a polymerization initiator used for curing the photopolymerizable coating composition of the present disclosure, those distributed as photopolymerization initiators can be used without limitation. For such a photopolymerization initiator, for example, a hydroxyketone polymer material such as oligo {2-hydroxy-2-methyl-1-phenylpropanone}, 1-hydroxydicyclohexyl phenylketone, 2-hydroxy-2-methyl-1-phenylpropan-1-one, 2,2-dimethoxy-1,2-diphenylethane-1-one, 1-{4 (2-hydroxyethoxy)phenyl}2-hydroxy-2-methyl-1-propane 1-one, 2,4,6-trimethylbenzoyl diphenyl phosphine oxide, and bis(2,4,6 trimethylbenzoyl)phenylphosphine oxide can be used.

[3. Additives]

Additives such as an antioxidant, a weathering resistant stabilizer, a toning agent, and a diluent that are generally blended into a paint or film material can be blended into the photopolymerizable coating composition of the present disclosure. Blending amounts thereof are not limited as long as the function of the photopolymerizable coating composition of the present disclosure does not deteriorate.

[4. Use of the Photopolymerizable Coating Composition]

The photopolymerizable coating composition of the present disclosure can be applied to the surface of various articles and cured and dried to form a coating (coating layer) that imparts stain-proofing and water-repelling functions on the surface of the article. While the article on which the coating layer can be formed is not particularly limited, particularly, a laminated film is advantageous in that the liquid photopolymerizable coating composition of the present disclosure can be simply applied. Among laminated films, a PPF for which stain-proofing and water-repelling functions are required is particularly useful as an article using the coating layer.

The most preferable photopolymerizable coating composition of the present disclosure for forming a PPF coating layer contains a component (a): a urethane (meth)acrylate, a component (b1): polymer containing a γ-methacryloxypropyl hepta(trifluoropropyl)-T8-silsesquioxane unit and having an acryloyl group in a side chain, a component (b2): a fluorine-containing group, hydrophilic group, lipophilic group, and UV reactive group-containing oligomer, and a component (b3): a photopolymerizable acrylic compound containing two or more of a multifunctional photopolymerizable acrylic compound and having no urethane units and having no fluorine atoms. When the component (a), the component (b1), the component (b2), and the component (b3) are used in combination, it is possible to provide the flexibility and strength suitable for protecting against scratches and impacts to the obtained coating layer. In addition, when the component (a), the component (b1), the component (b2), and the component (b3) are used in combination, the water-repelling and stain-proofing properties of the coating layer obtained are still maintained even after use outdoors for a long period in contrast to products in the related art. A laminated film in which the coating layer is provided will be described below in detail.

[Coating Layer]

A coating layer constituting the laminated film of the present disclosure includes a polymer obtained by curing the above photopolymerizable coating composition on a substrate layer in the presence of a polymerization initiator. The thickness of the coating layer is generally 1 to 100 μm, preferably 2 to 50 μm, and more preferably 3 to 30 μm. The structure of the polymer constituting such a coating layer is complicated and cannot be expressed by a single repeating unit or a uniform structural formula. In the present disclosure, the polymer constituting the coating layer is defined by a photopolymerizable compound contained in the photopolymerizable coating composition.

[Substrate Layer]

Regarding the substrate layer constituting the laminated film of the present disclosure, a film including a thermoplastic resin is preferable. Examples of the thermoplastic resin include resins such as a polyurethane resin, a polyester resin, an acetate resin, a polyether sulfone resin, a polycarbonate resin, a polyamide resin, a polyimide resin, a polyolefin resin, a (meth)acrylic resin, a polyvinyl chloride resin, a polyvinylidene chloride resin, a polystyrene resin, a polyvinyl alcohol resin, a polyarylate resin, a polyphenylene sulfide resin, and a norbornene resin. Specifically, a thermoplastic polyurethane, polycaprolactone (PCL), an acrylic acid polymer, a polyester, a polyacrylonitrile, a polyether ketone, a polystyrene, a polyvinyl acetate, and derivatives thereof are preferable. These resins may be used alone or a plurality of resins may be used in combination.

A particularly preferable substrate layer includes a thermoplastic polyurethane. Examples of the thermoplastic polyurethane include ARGOGUARD (registered trademark,) 49510, and ARGOGUARD (registered trademark) 49510-DV commercially available from SWM, Esmer URSPX86, Esmer URSPX93, and Esmer URSPX98 commercially available from Nihon Matai Co., Ltd., DUS202, DUS213, DUS235, DUS501, DUS601, DUS605, DUS614, DUS203, DUS220, DUS701, XUS2086, XUS2098, DUS451, and DUS450 commercially available from Sheedom Co., Ltd., and Unigrand XN2001, XN2002, XN2004 commercially available from Nippon Unipolymer Co., Ltd.. Among these, a polycaprolactone thermoplastic polyurethane using a polycaprolactone polyol as a polyhydroxy compound, a polycarbonate thermoplastic plastic polyurethane using a polycarbonate polyol, and a polyether thermoplastic polyurethane using a polyether polyol are preferable.

In the present disclosure, the thickness of the substrate layer is not particularly limited, and is generally 25 to 300 μm and preferably 100 to 200 μm.

[Adhesive Layer]

The adhesive layer constituting the laminated film of the present disclosure includes a pressure sensitive adhesive. Regarding the pressure sensitive adhesive used in the present disclosure, a known adhesive which exhibits adhesiveness at a PPF application temperature, that is, at a temperature of about 20 to about 30° C., and which is used for adhering a molded article formed of a thermoplastic polyurethane material to an article made of glass, a metal, a plastic, or paper can be used without limitation. Regarding such a pressure sensitive adhesive, a commercially available acrylic pressure sensitive adhesive and urethane pressure sensitive adhesive can be used. Preferably, an acrylic pressure sensitive adhesive is used. The thickness of the adhesive layer is not particularly limited, and is generally about 10 to 200 μm.

[Release Layer]

Preferably, a release layer is additionally laminated on the adhesive layer constituting the laminated film of the present disclosure. Regarding the material of the release layer, a known release material is used without limitation. For example, a resin film such as a polyester resin and a polyolefin resin, a cellophane paper, a glassine paper, or those of which surfaces are coated with a fluorine or silicone release agent can be used. The thickness of the release layer is not particularly limited, and generally about 20 to 200 μm.

[Protective Layer]

In the laminated film of the present disclosure, the outer surface of the coating layer can be covered with a protective layer depending on the form of storage, transportation, and sale. The material of such a protective layer is not limited and a generally used plastic film such as a polyethylene film or release paper can be appropriately selected.

[Production of Laminated Film]

Regarding a method of producing a laminated film of the present disclosure, a method suitable for formation and lamination of respective layers can be used without limitation. For example, when the laminated film of the present disclosure has a release layer and a protective layer, the laminated film of the present disclosure can be produced through the following processes.

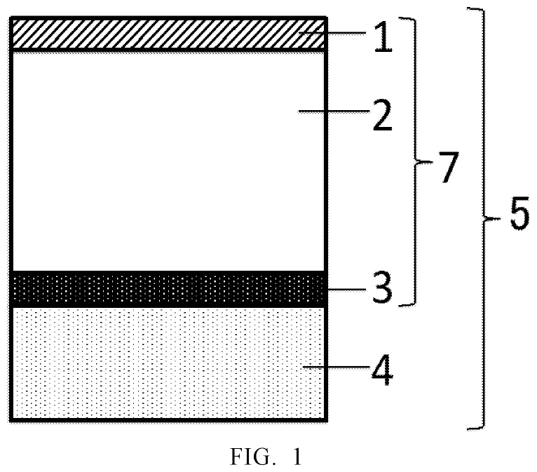

First, an adhesive layer is formed on the release-treated surface of the release layer. Then, the opened surface of the formed adhesive layer is brought into close contact with one surface of the substrate layer, and a laminate in which the substrate layer, the adhesive layer, and the release layer are in contact in this order is produced. Next, the above photopolymerizable coating composition is applied to the released surface of the substrate layer of the obtained laminate, and UV rays are emitted to the coating surface to cure the photopolymerizable coating composition. When curing is completed, a laminated film in which the coating layer, the substrate layer, the adhesive layer, and the release layer in contact in this order is obtained. In addition, the open surface of the coating layer is covered with a protective film. Therefore, a laminated film in which the protective layer, the coating layer, the substrate layer, the adhesive layer, and the release layer are in contact in this order is obtained. The obtained laminated film can be appropriately cut, wound, and packaged. FIG. 1 is a diagram schematically showing one example of a laminated film of the present disclosure. As shown in FIG. 1, a laminated film 5 of this embodiment includes a release layer 4, and a paint protection film (PPF) 7 applied on the release layer 4. The PPF 7 includes an adhesive layer 3, a substrate layer 2 and a coating layer 1 laminated in sequence over the release layer 4.

[PPF]

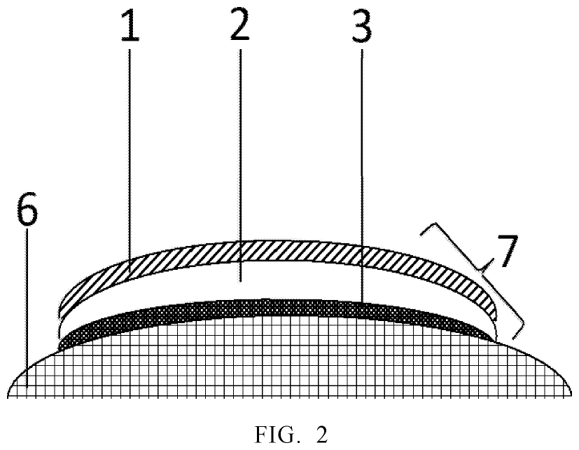

The laminated film of the present disclosure completed in this manner can be cut into an appropriate length unit, loaded or wound and used as a PPF. When the PPF is applied, the laminated film of the present disclosure is cut into a shape conforming to the shape and size of an application surface, the cut laminated film is stretched with an appropriate force, and the adhesive layer is brought into close contact with the application surface. FIG. 2 is a diagram schematically showing a state in which the laminated film of the present disclosure is used as a PPF. As shown in FIG. 2, the paint protection film (PPF) 7 is applied on an application surface 6, wherein the PPF 7 includes an adhesive layer 3, a substrate layer 2 and a coating layer 1 laminated in sequence.

In the laminated film of the present disclosure, the coating layer having excellent strength, smoothness, water repellency, and oil repellency has a function of mitigating an external stimulation to the working surface. On the other hand, the flexible substrate layer is brought into close contact with the application surface via the adhesive layer. After being used for a certain period, the laminated film can be removed without damage to the surface of the application surface.

### EXAMPLES

[Production of a polymer having a γ-methacryloxypropyl hepta(trifluoropropyl)-T8-silsesquioxane unit as an example of the component (b1)]

First, in the following procedure, γ-methacryloxypropyl hepta(trifluoropropyl)-T8-silsesquioxane was synthesized. Trifluoropropyltrimethoxysilane (100 g), THF (500 ml), deionized water (10.5 g) and sodium hydroxide (7.9 g) were put into a 4-neck flask with an internal volume of 1 L to which a reflux condenser, a thermometer and a dropping funnel were attached, and while stirring using a magnetic stirrer, heating was performed in an oil bath from room temperature until the temperature reached a temperature at which THF was refluxing. Stirring was continued for 5 hours from when the refluxing started and a reaction was completed. Then, the flask was removed from the oil bath, was left at room temperature overnight, and then set again in the oil bath, and heating and concentration were performed under a constant pressure until a solid was precipitated.

The precipitated product was filtered using a pressure filter including a membrane filter with a pore size of 0.5 Lm. Next, the obtained solid material was washed once with THF and dried at 80° C. for 3 hours using a reduced-pressure drying device, and 74 g of a colorless solid material powder was obtained.

The obtained solid material (65 g), dichloromethane (491 g), and triethylamine (8.1 g) were put into a 4-neck flask with an internal volume of 1 L to which a reflux condenser, a thermometer and a dropping funnel were attached, and cooling was performed to 3° C. in an ice bath. Next, γ-methacryloxypropyltrichlorosilane (21.2 g) was added thereto, and after it was confirmed that heating had subsided, removal from the ice bath was performed, and aging was performed at room temperature overnight without change. After washing with deionized water was performed three times, a dichloromethane layer was dehydrated with anhydrous magnesium sulfate, and magnesium sulfate was removed by filtration. Concentration was performed in a rotary evaporator until a viscous solid was precipitated, and 260 g of methanol was added and stirring was performed until a powder was formed. The powder was filtered using a pressure filter having a filter paper of 5 μm, and dried using a reduced pressure dryer at 65° C. for 3 hours, and 41.5 g of a colorless solid powder was obtained. The obtained solid was subjected to GPC, and ¹H-NMR measurement, and generation of the γ-methacryloxypropyl hepta(trifluoropropyl)-T8-silsesquioxane (5) represented by the following Formula (5) was confirmed.

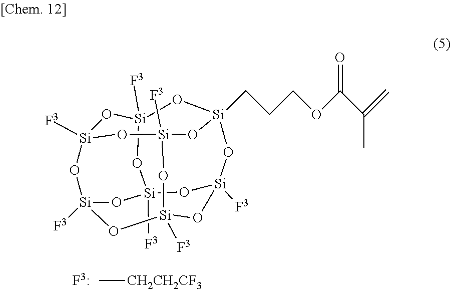

Next, in the following procedure, a polymer having a γ-methacryloxypropyl hepta(trifluoropropyl)-T8-silsesquioxane unit was synthesized.

The compound 5 (25 g), Silaplane FM0721 (6.3 g, commercially available from JNC), 2-hydroxylethyl methacrylate (18.8 g), methyl methacrylate (12.5 g), and methyl ethyl ketone (62 g) were put into a four-neck round-bottom flask to which a reflux device and a dropping funnel were attached and which was sealed with a nitrogen seal, and refluxing and degassing were performed for 15 minutes using an oil bath. Then, a solution in which azobisisobutyronitrile (0.48 g) and mercaptoacetic acid (0.054 g) were dissolved in methyl ethyl ketone (4.8 g) was added to initiate polymerization. A solution containing a copolymer obtained when, 3 hours after the polymerization was initiated, azobisisobutyronitrile (0.48 g) was dissolved in methyl ethyl ketone (4.3 g) and added, and aged for 5 hours was obtained. Moreover, as a polymerization inhibitor, paramethoxyphenol (0.16 g), and dibutyltin dilaurate (0.15 g, commercially available from Showa Denko) were dissolved in methyl ethyl ketone (1.5 g) and added thereto. Then, Karenz AOI (26.4 g) was added dropwise using a dropping funnel so that the temperature of the solution was changed from 35° C. to 50° C., and after the dropwise addition, aging was performed at 45° C. for 3 hours.

Then, methanol (9 g) was added and treated, and then paramethoxyphenol (0.16 g) was additionally added, and the mixture was diluted with methyl isobutyl ketone (107.3 g), and thereby a solution containing 30 weight % of a desired polymer (A-1) was obtained.

The obtained polymer (A-1) had a weight average molecular weight (Mw) of 42,000 and a polydispersity index (Mw/Mn) of 1.9. The weight average molecular weight and the polydispersity index were measured through gel permeation chromatography (GPC, model number: Alliance 2695, commercially available from Waters, column: Shodex GPC KF-804Lx2 (in series), guard column: KF-G). According to GPC analysis, it was confirmed that the obtained polymer (A-1) was a polymer containing a γ-methacryloxypropyl hepta(trifluoropropyl)-T8-silsesquioxane unit and having an acryloyl group in a side chain.

[Production of a Photopolymerizable Coating Composition]

Materials in the compositions shown in Table 1 were mixed and stirred to produce photopolymerizable coating compositions of the present disclosure and photopolymerizable coating compositions for comparison. The materials used are shown below.

### (Component (a))

P7-532: urethane acrylate product commercially available from Kyoeisha Chemical Co., Ltd.
RUA075: urethane acrylate product commercially available from Asia Industry Co., Ltd.
RUA012: urethane acrylate product commercially available from Asia Industry Co., Ltd.

(Component (b1))
XUA008: The polymer (A-1) produced by the above method. A polymer containing a γ-methacryloxypropyl hepta(trifluoropropyl)-T8-silsesquioxane unit and having an acryloyl group in a side chain.

(Component (b2))
RS-75: fluorine additive MEGAFACE (registered trademark, commercially available from DIC). A fluorine-containing group, hydrophilic group, lipophilic group, and UV reactive group-containing oligomer.

(Component (b3))
M309: product Aronix (registered trademark, commercially available from Toagosei Co., Ltd.) Trimethylolpropane triacrylate.
DPCA-120: product KAYARAD (commercially available from Nippon Kayaku Co., Ltd.) Caprolactone modified dipentaerythritol hexaacrylate.
A-HD-N: product (commercially available from Shin Nakamura Chemical Co., Ltd.) 1,6-Hexanediol diacrylate.
A-DPC: product (commercially available from Shin Nakamura Chemical Co., Ltd.) Tricyclodecane dimethanol diacrylate.

(Other Components)
Irgacure 127 (not listed in Table 1): photopolymerization initiator product commercially available from BASF. This was added at 7 weight % with respect to a total amount of the photopolymerizable coating composition.

[Production of a Laminated Film]

A thermoplastic polyurethane film “ArgoGuard (registered trademark) 49510” commercially available from SWM (with a thickness of about 152 m) was used as a substrate layer.

Separately, a commercially available acrylic pressure sensitive adhesive was applied to a release layer subjected to a release treatment with a silicone resin, and dried at 120° C. for 5 minutes. Thus, an adhesive layer with a thickness of 40 μm was formed on one surface of the release layer.

Next, an open surface of the adhesive layer and the substrate layer were press-bonded using a rubber roller and aged at 45° C. for 1 day. Thus, a laminated film in which the substrate layer, the adhesive layer, and the release layer were in contact in this order was obtained.

The photopolymerizable coating composition produced using the above material was applied to the open surface of the substrate layer using a wire bar and dried at 80° C. for 3 minutes. Then, the photopolymerizable coating composition was cured using a fusion UV lamp mounted belt conveyor curing unit (commercially available from Heraeus) at a cumulative light amount of 500 mJ/cm². A coating layer with a thickness of 4 μm was formed on the substrate layer. A laminated film in which the coating layer, the substrate layer, the adhesive layer, and the release layer were in contact in this order was obtained.

[Evaluation of the Laminated Film Before UV Exposure]

(1) Water Contact Angle

1.8 μl of distilled water was added dropwise to the surface of the coating layer of the laminate, and an angle (water contact angle) formed between distilled water droplets and the surface of the coating layer of the laminate was measured. A contact angle meter Drop Master 400 (commercially available from Kyowa Interface Science, Inc.) was used as a measurement device. The measured value was evaluated according to the following criteria. The results are shown in Table 1.
A: The water contact angle was 100 degrees or more. Water-repelling properties were favorable.
B: The water contact angle was larger than 95 degrees and less than 100 degrees. Water-repelling properties were slightly poor.
C: The water contact angle was less than 95 degrees. Water-repelling properties very poor.

(2) Water Sliding Angle

25 ml of distilled water was added dropwise to the surface of the laminate, and a sample table was slowly inclined. An angle (water sliding angle) at which an angle at which droplets advance was changed by 5 dots was measured. DROP MASTER 400 was used as a measurement device. The measured value was evaluated according to the following criteria. The results are shown in Table 1.
A: The water sliding angle was 20 degrees or less. Water-repelling properties were favorable.
B: The water sliding angle was larger than 20 degrees and less than 30 degrees. Water-repelling properties were slightly poor.
C: The water sliding angle was 30 degrees or more. Water-repelling properties were very poor.

(3) Surface Free Energy

The contact angle of the surface of the laminate was measured for two liquid samples (distilled water and diiodomethane). The measured value was applied to the YOUNG-DUPRE equation (a theoretical equation regarding wettability and adhesiveness between a solid and a liquid) and values such as a work of adhesion W_{SL} of the laminate and the liquid were calculated. In addition, a surface free energy was calculated based on the obtained values and the OWENS-WENDT theory. DROP MASTER 400 was used as a measurement device. The calculated value was evaluated according to the following criteria. The results are shown in Table 1.
A: The surface free energy was 21 mJ/m² or less. Stain-proofing properties were favorable.
B: The surface free energy was larger than 21 mJ/m² and less than 25 mJ/m². Stain-proofing properties were slightly poor.
C: The surface free energy was 25 mJ/m² or more. Stain-proofing properties were very poor.

[Evaluation of the laminated film after UV exposure] The laminated film was exposed with ultraviolet rays in a UV fluorescent lamp type accelerated weathering resistance tester QUV (commercially available from Q-LAB). Regarding exposure conditions, the following Steps 1, 2, and 3 (one cycle) according to ASTM G154 CYCLE 2 were performed over a total of 12 cycles. Ultraviolet rays were emitted from the side of the coating layer of the laminated film.
Step 1: UV emission (UV emission amount: 0.71 W/m², temperature: 60° C., time: 4 hours)
Step 2: condensation (temperature: 50° C., time: 4 hours)
Step 3: return to Step 1

The laminated film after exposure was evaluated according the above methods (1), (2), and (3) and criteria. The results are shown in Table 1.

TABLE 1

| | | | | | | | | | | | Comparative | | |
|---|---|---|---|---|---|---|---|---|---|---|---|---|---|
| | | | | Examples | | | | | | | examples | | |
| | | | | 1 | 2 | 3 | 4 | 5 | 6 | 7 | 1 | 2 | 3 |
| Photo- | (a) | P7-532 | (wt %) | 4.9 | 4.9 | | | 27.6 | 4.9 | 4.9 | 4.9 | 4.9 | 4.9 |
| polymerizable | | RUA075 | (wt %) | | | | 4.9 | | | | | | |
| coating | | RUA012 | (wt %) | | | 4.9 | | | | | | | |
| composition | (b1) | XUA008 | (wt %) | 0.8 | 0.8 | 0.8 | 0.8 | 1.6 | 1.6 | 1.6 | | 1.6 | |
| | (b2) | RS-75 | (wt %) | 0.8 | 0.8 | 0.8 | 0.8 | 1.6 | 1.6 | 0.3 | | | 1.6 |
| | (b3) | M309 | (wt %) | 88.6 | | 88.6 | 88.6 | 64.3 | 64.3 | 88.3 | 90.2 | 88.6 | 88.6 |
| | | DPCA-120 | (wt %) | | 88.6 | | | | | | | | |
| | | A-HD-N | (wt %) | 4.9 | 4.9 | 4.9 | 4.9 | | | 4.9 | | 4.9 | 4.9 |
| | | ADPC | (wt %) | | | | | 4.9 | 27.6 | | 4.9 | | |
| Evaluation | Before UV | Water | (deg.) | 103 | 106 | 105 | 106 | 105 | 106 | 105 | 77 | 100 | 107 |
| | exposure | contact | Determination | A | A | A | A | A | A | A | C | A | A |
| | | angle | | | | | | | | | | | |
| | | Water | (deg.) | 18 | 17 | 17 | 19 | 19 | 20 | 15 | 24 | 14 | 23 |
| | | sliding | Determination | A | A | A | A | A | A | A | B | A | B |
| | | angle | | | | | | | | | | | |
| | | Surface | (mJ/m²) | 17 | 16 | 17 | 17 | 15 | 16 | 21 | 43 | 22 | 15 |
| | | free energy | Determination | A | A | A | A | A | A | A | C | B | A |
| | After UV | Water | (deg.) | 101 | 103 | 101 | 101 | 102 | 102 | 100 | 77 | 96 | 105 |
| | exposure | contact | Determination | A | A | A | A | A | A | A | C | C | A |
| | | angle | | | | | | | | | | | |
| | | Water | (deg.) | 12 | 15 | 17 | 13 | 15 | 18 | 25 | 19 | 13 | 13 |
| | | sliding | Determination | A | A | A | A | A | A | B | A | A | A |
| | | angle | | | | | | | | | | | |
| | | Surface | (mJ/m²) | 19 | 18 | 19 | 20 | 18 | 16 | 20 | 41 | 25 | 17 |
| | | free energy | Determination | A | A | A | A | A | A | A | C | C | A |

As shown in the results in Table 1, in the laminated film in which a coating layer was formed using the photopolymerizable coating composition of the present disclosure, after UV exposure, favorable water-repelling and stain-proofing properties were maintained. On the other hand, in the laminated film of the comparative example not containing the component (b1) and/or component (b2) of the present disclosure, water-repelling and stain-proofing properties before exposure and/or after exposure were inferior.

The photopolymerizable coating composition of the present disclosure is highly useful as a water-repelling and stain-proofing coating material. The laminated film having a coating layer using the photopolymerizable coating composition of the present disclosure is highly useful as a PPF. Objects to which the PPF made of the laminated film of the present disclosure can be applied, can be expected to be a wide range of objects such as ships, buildings, electronic products, display products, interior finishings, furniture, factory facilities, industrial devices, and medical devices in addition to vehicles such as automobiles and motorbikes.

What is claimed is:

1. A photopolymerizable coating composition, comprising:
a component (a): a urethane (meth)acrylate and a component (b): photopolymerizable (meth)acrylic compounds, as photopolymerizable components,
wherein the component (a) and the component (b) are mixed so that a proportion of the component (a) is 1 weight % or more and 50 weight % or less, and a proportion of the component (b) is 50 weight % or more and 99 weight % or less with respect to a total amount of the photopolymerizable components, and
wherein the component (b) comprises,
a component (b1): a photopolymerizable acrylic compound having a structural unit derived from a fluorosilsesquioxane derivative represented by the following Formula (1);
a component (b2): a fluorine surfactant, and
a component (b3): a photopolymerizable acrylic compound having no urethane units and having no fluorine atoms: 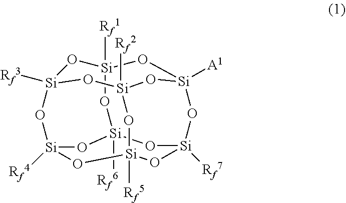
wherein in Formula (1), R_{f}¹ to R_{f}⁷ each independently represent a linear or branched fluoroalkyl group having 1 to 20 carbon atoms in which any methylene is optionally substituted with an oxygen atom; a fluoroaryl group having 6 to 20 carbon atoms in which at least one hydrogen atom is substituted with a fluorine atom or a trifluoromethyl group; or a fluoroarylalkyl group having 7 to 20 carbon atoms in which at least one hydrogen atom in an aryl group is substituted with a fluorine atom or a trifluoromethyl group, and A¹ is a group represented by the following Formula (1-1) or Formula (1-2), 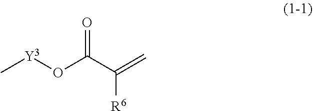
in Formula (1-1), Y³ represents an alkylene group having 2 to 10 carbon atoms, and R⁶ represents a hydrogen atom, a linear alkyl group having 1 to 5 carbon atoms, a branched alkyl group having 3 to 5 carbon atoms, or an aryl group having 6 to 10 carbon atoms, 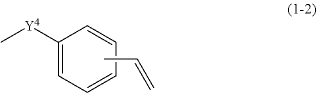
in Formula (1-2), Y⁴ represents a single bond or an alkylene group having 1 to 10 carbon atoms.

2. The photopolymerizable coating composition according to claim 1,
wherein the component (b1) has a structural unit derived from γ-methacryloxypropyl hepta(trifluoropropyl)-T8-silsesquioxane represented by the following Formula (1-3), 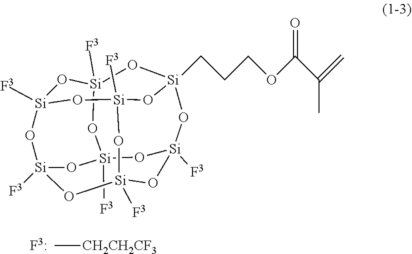
and,
wherein the component (b2) is a perfluoropolyether compound which has a perfluoropolyether framework and has a (meth)acryloyl group as a photopolymerizable unsaturated group at one end or both ends.

3. An article having a coating layer formed of a cured product of the photopolymerizable coating composition according to claim 1.

4. A laminated film in which a coating layer formed of a cured product of the photopolymerizable coating composition according to claim 1, a substrate layer formed of a thermoplastic polyurethane, an adhesive layer formed of a pressure sensitive adhesive, and a release layer whose surface is covered with a fluorine release agent or a silicone release agent are in contact in this order.

5. A paint protection film using the laminated film according to claim 4.

6. An article having a coating layer formed of a cured product of the photopolymerizable coating composition according to claim 2.

7. A laminated film in which a coating layer formed of a cured product of the photopolymerizable coating composition according to claim 2, a substrate layer formed of a thermoplastic polyurethane, an adhesive layer formed of a pressure sensitive adhesive, and a release layer whose surface is covered with a fluorine release agent or a silicone release agent are in contact in this order.
